(19) United States
(12) Patent Application Publication
(10) Pub. No.: US 2012/0226448 A1
(43) Pub. Date: Sep. 6, 2012

(54) METHOD AND DEVICE FOR MOVING AN OBJECT

(75) Inventors: Joseph Thomas Marie Mutsaerts, Zurich (CH); Johannes Blom, Achterveld (NL); Martin Scholer, Bartenheim (FR)

(73) Assignee: AKTIEBOLAGET SKF, Goteborg (SE)

(21) Appl. No.: 13/408,247

(22) Filed: Feb. 29, 2012

(30) Foreign Application Priority Data
Mar. 2, 2011 (DE) 10 2011 004 963.0

(51) Int. Cl. G06F 19/00; G01L 1/14; G01L 1/22; G01L 1/00

(52) U.S. Cl. 702/41; 73/862.625; 73/862.626; 73/862.627

(57) ABSTRACT

In order to move an object, a handle is attached to the object. The handle includes at least one sensor configured to detect a force being applied to the handle and to generate at least one sensor output signal in accordance therewith. A motorized object driving apparatus is in electrical communication with the at least sensor and is configured to move the object based on the at least one sensor output signal in the direction of the force being applied to the handle.

### CROSS-REFERENCE

The present application claims priority to German patent application no. 10 2011 004 963.0 filed on Mar. 2, 2011, the contents of which are incorporated herein by reference.

### TECHNICAL FIELD

The invention generally relates to a concept for moving an object using a handle that is attachable to the object to be moved and an object moving device in electrical communication therewith.

### KNOWN ART

Numerous concepts for mechanically supporting movement of especially heavy and/or difficult-to-access objects are well known. Servo drives, for example, are often used for this purpose. In motor vehicles, windows, for example, can be controlled using electric power window lifters that include servo motors electronically coupled to remotely controllable switches. The steering of vehicles is also usually facilitated by servo-assisted power steering.

As another example, cranes may be remotely controllable using levers and keyboards in a control console and are often used for lifting or lowering heavy loads. As a further example, actuators in industrial robots, such as for example gripper arms, can be remotely controlled in order to thereby move large and/or heavy objects.

However, in all of the above-described concepts for moving difficult-to-access and/or heavy objects, the objects are moved at a distance from the remote control device. Therefore, an actual, direct contact between the human/user and the object to be moved does not exist, such that an intuitive movement and/or haptic perceptions of the object are not taken into account.

### SUMMARY

Therefore, in one aspect of the present teachings, an improved concept is disclosed for moving particularly difficult-to-move objects, in particular so that more intuitive and more precise movements of such objects are possible.

In another aspect of the present teachings, a device for moving an object uses a handle that is attached to or is attachable to the object to be moved. The handle includes at least one sensor configured to detect a force being applied to the handle, and in accordance therewith generates at least one sensor output signal for actuating a motorized object driving apparatus coupled to the sensor. Based on the sensor output signal(s), the motorized object driving apparatus is configured to move the object in the direction of the force being applied to the handle.

By directly attaching an object manipulating apparatus, such as for example a handle having at least one specialized force and/or movement sensor, to an object to be moved, the object can be moved by operating the handle. The handle and/or its sensor is coupled with the motorized object driving (moving) apparatus (device), which is configured to move the object, e.g., by applying a much greater force than the force applied by the user to the handle or sensor.

Of course, in the alternative, a force reduction could also take place, i.e. the object can also be moved with a lesser force than the force applied by the user to the handle or sensor. The handle and the object driving apparatus therefore act, in effect, as a type of servo system or servo drive.

In one exemplary embodiment, the device for moving an object may further comprise the motorized object driving apparatus, which is coupled or coupleable with the sensor of the handle, in order to move the object in the direction of the force applied to the handle, based on the sensor output signal.

In another exemplary embodiment, a method for moving an object may include:
Applying a force to a handle, which is attachable to the object to be moved, wherein the handle has a sensor configured to detect the force applied to the handle;
Providing a sensor output signal in accordance with (or representative of) the force detected by the sensor of the handle; and
Moving the object in the direction of the force applied to the handle, based on the sensor output signal, using a motorized object driving apparatus coupled to the sensor of the handle and actuated thereby.

According to another exemplary embodiment, the handle can be fixedly or permanently attached to the object. For example, in the case of especially heavy objects, the handle could be bolted or welded to the object. Other methods for joining/attaching the handle and object in a highly durable manner in view of the amount of force to be applied thereto are of course also within the scope of the present teachings

According to another exemplary embodiment, the handle could instead be a separate, mobile manipulating apparatus, which is only temporarily coupled to the object when it is necessary to move the object. For example, (electro)magnets or suction cups may be provided on the handle to effect the detachable coupling to the object to be moved.

The handle can be coupled to the motorized object driving apparatus in a variety of different ways. Especially in the case of a handle that is usable in an independent, mobile and universal manner for moving objects, the handle could be coupled wirelessly with the motorized object driving apparatus, e.g., optically or by a wireless (RF) interface, to control the motor of the motorized object driving apparatus. For example, a fixed prescribed communication protocol could be used for communications between the handle and object driving apparatus, so that the handle can communicate with a variety of object driving devices. A wired coupling is also possible, e.g., for handles that are fixedly or permanently attached to the object. Nevertheless, it is noted that the type of electrical coupling between the handle and object driving apparatus is not dependent on the expected spatial range of motion of the object, on which the handle is also located. However, a wireless coupling of the handle/sensor and the object driving (moving) apparatus makes sense especially in the case of a large expected radius of movement.

The force that acts on the sensor is measured by the force and/or movement sensor(s) built into or disposed on the handle. In such embodiments, one or both of compressive and tensile forces can be measured. The force transducer(s) can be based on a variety of sensor concepts. For example, capacitive, magnetic and/or piezo-resistive force/movement sensors may be utilized with the present teachings. In addition or in the alternative, sensors based on strain gauges are also possible.

In order to avoid undesirably triggered object movements, the handle can be configured to be activatable and deactivatable, so that in an activated state of the handle the sensor output signal(s) is (are) transmitted to the object driving apparatus, and in a deactivated state of the handle, no sensor output signal is transmitted to the object driving apparatus.

According to another exemplary embodiment, the object driving apparatus may comprise a motor-driven object handling unit that is adapted to or is suitable for the object to be moved. For large containers, this could for example be a lifting platform or a crane configured to move the container in a manner controlled by the handle on the container. For smaller objects, such as for example lifting or lowering beds or tabletops, a smaller motor-driven lifting device would suffice.

A variety of different motors may be utilized without limitation for the motorized object driving apparatus. The motor(s) is (are) preferably matched to the size and weight of the object to be moved. Electric motors, and in particular linear motors, especially when it concerns translational movements of the object, are especially suitable. However, such linear movements can of course also be effected by rotating motors, if a transmission for converting rotational movement into translational (linear) movement is also used.

In another exemplary embodiment, after the force applied to the handle attached to the object is detected by the force sensor(s), the force sensor(s) generate(s) at least one corresponding sensor output signal. That is, the sensor output signal(s) correspond(s) to or is (are) representative of the force being applied to the handle and serve(s) as a control signal for one, two, or three motor(s) (for X, XY, or XYZ movements, respectively) of the object driving (moving) apparatus. Based on the control signal(s), the motor(s) move(s) the object in the direction of the force being applied to the handle on the object. The handle located directly on the object to be moved thus serves, according to this aspect, in effect as a remote control for the motorized object driving apparatus.

If the handle provides a direct contact between the user and the object to be moved, the object, supported by the object driving apparatus, can be moved by the user directly and/or instantaneously by a corresponding movement of the handle located on the object. As a result, faster, more accurate and more intuitive object movements are possible than with conventional remote controls.

Further objects, embodiments, advantages and designs will be explained in the following with the assistance of the exemplary embodiments and the appended Figures.

### BRIEF DESCRIPTION OF THE DRAWINGS

FIG. 1 shows a schematic representation of a device for moving an object according to an exemplary embodiment of the present teachings.

FIG. 2 shows a block diagram of a handle and an object driving apparatus according to an exemplary embodiment of the present teachings.

FIG. 3 shows a schematic flow chart of a method for moving an object according to an exemplary embodiment of the present teachings.

### DETAILED DESCRIPTION OF THE INVENTION

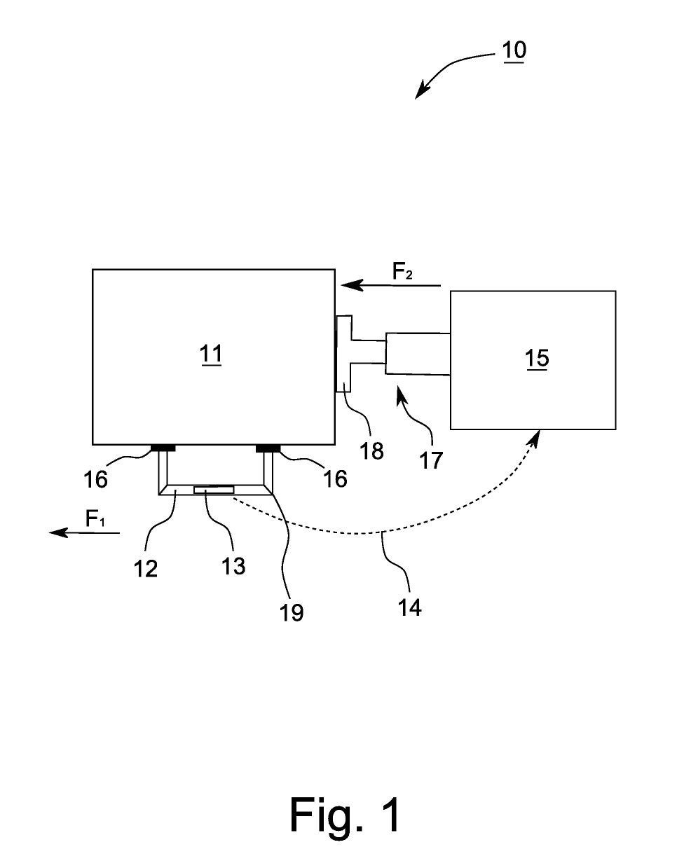

FIG. 1 shows a schematic representation of a device 10 for moving an object 11 according to an exemplary embodiment.

The apparatus 10 includes a handle 12 that is attachable or is attached to the object 11 to be moved. The handle 12 includes at least one sensor 13 configured to detect a force F₁ being applied to the handle 12 (for example by a human) and to generate at least one sensor output signal 14 in accordance therewith. A motorized object driving apparatus (actuator) 15 can be coupled or is coupled with the sensor 13 and/or the sensor signal 14 of the handle 12 and is configured to move the object 11 in the direction of the force F₁ being applied to the handle 12, based on the sensor output signal(s) 14. The handle 12 may be attached to the object 11 such that it is not movable relative to the object 11. In the alternative, the handle 12 may be attached to the object 11 so as to be movable relative to the object 11, e.g., the handle 12 may be pivotable relative to the object 11 and/or may be linearly movable relative to the object 11.

In order to facilitate the movement of the object 11 by a human user, at least one of the forces F₂ applied by the object driving apparatus 15 can correspond, in terms of the magnitude, to a multiple of the force F₁ applied by the user to the handle 12, i.e. F₂>F₁. In this case, the user can thereby move a heavy object 11 in a desired direction by applying a relatively small force F₁ to the handle 12. In the alternative, the force F₂ applied by the object driving apparatus 15 can also correspond, in terms of the magnitude, to a fraction of the force F₁ being applied by the user to the handle 12, i.e. F₂<F₁. In this case, the user can finely control the movement of a lighter object 11. The sensor(s) 13 are preferably configured to detect the amount of force being applied thereto and to output at least one signal that is proportional to or representative of the amount of force being applied thereto.

The handle 12 is not required to be fixedly or permanently connected with the object 11 to be moved. Although exemplary embodiments of the present teachings include such fixed, permanent connections, as could be produced for example by bolting or welding, the handle 12 is preferably formed as a separate component that is usable in a mobile or detachable manner. Coupling elements 16, e.g., activatable electromagnets, suction cups, or the like, may be provided for detachably coupling the handle 12 with the object 11 to be moved. This embodiment has the advantage that the handle 12 may be used not only for moving a single object 11, but also for moving different objects that are independent of each other.

In order to be able to use the handle 12 in the most versatile manner, i.e. for moving different objects 11 using different object driving apparatuses 15, the handle 12 can have an interface for transmitting the sensor output signal(s) 14 to the one or more object driving apparatuses 15. The interface preferably operates with a predefined communication protocol. The communication interface can be either wired or wireless. Nowadays, a variety of efficient wireless communication methods are available and wireless communication interfaces are particularly advantageous when the handle 12 is configured to be detachably attachable to a variety of objects 11 to be moved.

If for example the force sensor(s) 13 located on the handle 12 is (are) designed to detect very small forces, it may be advantageous to implement the handle 12 so that it is activatable and deactivatable. In this case, undesired object movements caused by unintended forces F₁ being applied to the handle 12 can be prevented. For example, in one embodiment, the sensor output signal(s) 14 can be transmitted to the object driving apparatus 15 in the activated state of the handle 12. On the other hand, in the deactivated state of the handle 12, no sensor output signal is transmitted the object driving apparatus 15, so that undesired movements are prevented.

The object driving apparatus 15 preferably comprises at least one actuator and/or at least one motorized object handling apparatus that is configured to move the object 11 linearly (translationally) and/or rotationally in accordance with the sensor output signal(s) 14, optionally by an amount that is proportional to the amount of force detected by the sensor(s) 13. In the exemplary embodiment illustrated in FIG. 1, the object driving apparatus 15 includes a piston assembly 17 configured to move the object 11 linearly or translationally (here: from right to left) using a piston end surface 18. For a linear or translational movement in the vertical direction, the object driving unit 15 could also include, for example, a lifting platform or a crane configured to lift or lower the object 11 as necessary in accordance with the sensor output signal(s) 14.

The user preferably has direct and/or instantaneous contact with the object 11 to be moved via the handle 12, in order to be able to experience a haptic perception (touch sensation) of the object 11. Therefore, if the object 11 is, for example, a tabletop and the handle 12 is attached to it, the tabletop can be respectively lifted or lowered by applying a small upward or downward force F₁ using the object driving apparatus 15, such as for example a lifting device coupled with the handle 12 or its sensor 13. Because the user can feel the actual movement of the object 11 via the handle 12 while the object 11 is moving, the user can better adjust the amount and the direction of the force being applied to the handle 12 in order to move the object 11 in the direction and at the speed most desired by the user.

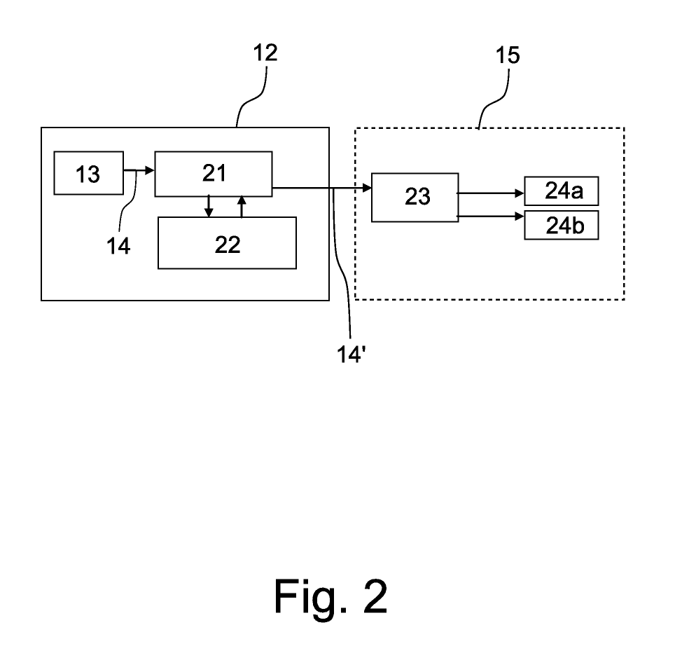

In the following, the handle 12 and the object driving apparatus 15 coupled thereto will be discussed in more detail with assistance of FIG. 2.

As shown schematically in FIG. 2, at least one sensor 13, e.g., a force and/or movement sensor, is provided in or on the handle 12. Such force sensors exist in numerous designs. For example, the sensor(s) 13 could comprise one or more of capacitive, magnetic, and/or piezo-resistive force sensors. Strain gauges are also usable as force sensors according to the present teachings. Depending on the type of sensor that is used, the best position for locating the sensor in or on handle may differ. For example, a strain gauge could be installed at position 13 indicated in FIG. 1, whereas it may be advantageous to attach piezo-resistive force sensors to the handle corners 19.

In the activated state, the sensor(s) 13 generate(s) at least one sensor output signal 14 in accordance with the force F₁ being applied to the handle 12. This signal 14 may, in some embodiments, be processed using appropriate electronic processing circuits 21, before it is transmitted via a communication interface to the object driving unit 15. This communication can be based on analog signals or digital signals, e.g., serially-transmitted digital signals (a bus). The signal processing can for example include amplification of the signal 14.

As is implied by reference number 22, other components 22 can be provided on or in the handle 12, in order for example to activate or deactivate the handle 12, or also to control the movement of object 11. An indicator or display could also for example be provided on the handle 12 in order to, e.g., display the activation state of handle 12, e.g., an ON/OFF signal. Furthermore, the indicator or display may show the user in which direction and/or with what force the object 11 is currently being moved by the object driving apparatus 15. In this case the communication interface between the handle 12 and the object driving apparatus 15 must be implemented in a bidirectional manner

To increase handling comfort, the handle 12 could be formed, for example, at least partially from a soft, elastic foam and/or rubber. Such embodiments of the handle 12 also simultaneously offer shock and/or impact protection.

The sensor output signal 14′ processed by a processing circuit 21 is then transmitted via the communication interface to the object driving apparatus 15. The processed sensor output signal 14′ can be supplied to at least one motor controller 23, which controls or regulates at least one motor 24a, b in accordance with the processed sensor output signal 14′. Return signals, which provide feedback information concerning the operational state(s) of the motor(s) 24a, b, are required between the motor(s) 24a, b and the motor controller(s) 23 to enable an active control or regulation of the motor(s) 24a, b.

One or more motor 24a, b of the motorized object driving apparatus 15 can be an electric motor, preferably an electric linear motor. Linear motors are especially advantageous if the object 11 should be moved linearly or translationally by the object driving apparatus 15. However, rotating motors are also usable in accordance with other exemplary embodiments. A translational movement can also be achieved by interleaving a motion converting device (e.g., a transmission) between the rotating motor(s) and the object to be moved. If it is intended to move the object 11 circularly, e.g., rotationally, rotating motors would thus be advantageous. In order to realize more complex movement sequences, as indicated in FIG. 2, a plurality of motors 24a, b can be used, in order to allow both translational and rotational movement of the object 11. The electric motor(s) 24a, b can be formed either with (carbon) brushes or without brushes.

Exemplary embodiments of the present teachings include not only the handle 12 and the object driving apparatuses 15 coupled with the handle, but also corresponding methods for moving the object 11. Moreover, movements in two or more dimensions can be realized with appropriate modifications. In this case, appropriate sensors 13 for controlling corresponding motors are preferably provided in or on the handle 12.

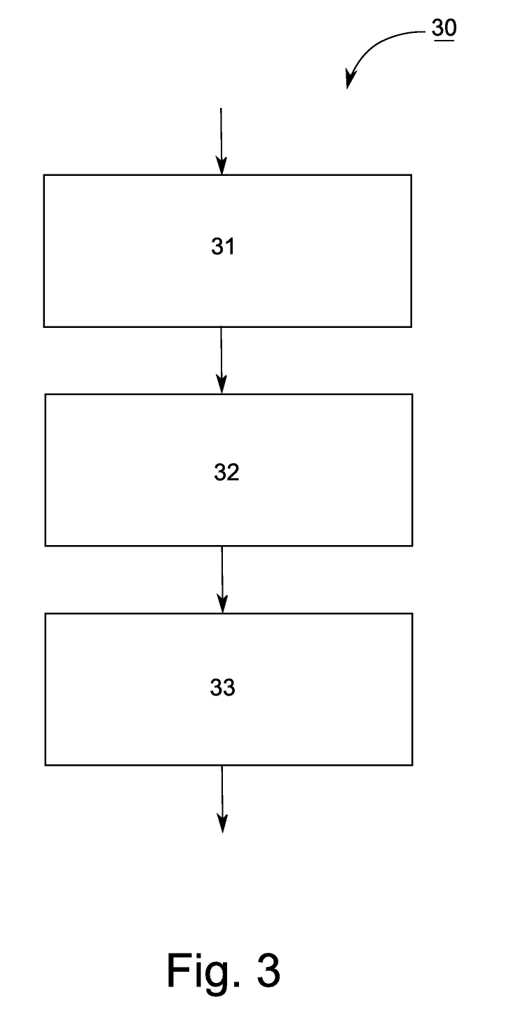

An exemplary flow diagram for a representative method 30 according to the present teachings is schematically illustrated in FIG. 3.

The representative method 30 comprises a first step 31 in which a force F₁ is applied to a handle 12 that is attached (permanently or detachably) to the object 11 to be moved. As described above, the handle 12 includes at least one force sensor 13 configured to detect the force F₁ being applied to the handle 12. The handle 12 is attached to the object 11 before the application of the force.

Then, in step 32, a sensor output signal 14 is provided or generated by the force sensor(s) 13 in accordance with the force F₁ detected by the sensor 13. The sensor output signal 14 is preferably proportional or representative of the amount and the direction of force being applied to the handle 12.

After the sensor output signal 14 or a signal 14′ derived therefrom has been transmitted (e.g., wirelessly) to a motorized object driving apparatus 15, in a step 33 the object 11 is moved by the object driving apparatus 15 in the direction of the force F₁ being applied to the handle 12 based on the sensor output signal 14. As this concept was explained above in detail, it is not necessary to further describe it here.

According to the concept for moving an object disclosed herein, a direct or instantaneous movement of, e.g., heavy objects is possible by a user or operator of the handle 12 (attached to the object). The user is, through the handle 12, in direct contact with the object 11 during the movement of the object 11, so that its movement, supported by the object driving apparatus 15, can be perform intuitively, accurately, and with a haptic perception. Therefore, the remote controlling of the object driving apparatus 15 takes place via the handle 12 and/or its sensor 13 located on the object 11 such that the user receives movement feedback information directly from the feel of the moving object 11 (via the handle 12). The remotely-controlled object driving apparatus 15 in turn acts on the object 11 to be moved through an actuator 17, 18, so that a circuit (control) from the handle 12 to the object driving apparatus 15, from there to the object 11, and from this back to handle 12, effectively results. Exemplary embodiments thus support an intuitive acceleration, braking, and/or stopping of, e.g., heavy or unwieldy objects.

Through the concept presented here, filigree or fine movements of, e.g., heavy objects not movable by human power alone are thus possible.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved object moving devices and methods for manufacturing and using the same.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### REFERENCE NUMBER LIST

10 Device for moving an object
11 Object to be moved
12 Handle
13 Force sensor
14 Sensor output signal
15 Object driving apparatus
16 Coupling element
17 Piston assembly
18 Piston end surface
19 Handle corner
21 Processing circuit
22 Further handle components (amplifier circuit)
23 Motor controller
24 Motor
30 Method for moving an object
31 Applying a force to a handle
32 Providing a sensor output signal
33 Moving the object

1. An object moving device comprising:
a handle configured to be attachable to the object,
at least one sensor disposed in or on the handle, the at least one sensor being configured to detect a force being applied to the handle by a user and to generate at least one sensor output signal in accordance therewith; and
a motorized object driving apparatus in electrical communication with the at least one sensor and configured to move the object based on the at least one sensor output signal in the direction of the detected force being applied to the handle.

2. The device according to claim 1, wherein the handle is fixedly attached to the object.

3. The device according to claim 1, wherein the handle is detachably attachable to the object.

4. The device according to claim 1, wherein the at least one sensor comprises at least one sensor selected from the group consisting of capacitive, magnetic, piezoelectric and strain-gauge-based force sensors.

5. The device according to claim 1, wherein the handle is configured to be activatable and deactivatable such that, in an activated state of the handle, the at least one sensor output signal is generated and, in a deactivated state of the handle, no sensor output signal is generated.

6. The device according to claim 1, further comprising at least one processing device configured to amplify the at least one sensor output signal and to transmit an amplified sensor output signal to at least one motor controller located in the motorized object driving apparatus.

7. The device according to claim 1, wherein the motorized object driving apparatus is configured to move the object at least one of linearly and rotationally and further comprises at least one motor that is controllable by the at least one sensor output signal.

8. The device according to claim 6, wherein the at least one motor comprises at least one electric linear motor.

9. The device according to claim 1, wherein the at least one sensor and the motorized object driving apparatus are configured to communicate via a wireless communication interface, in order to transmit the at least one sensor output signal or a signal derived therefrom from the handle to the motorized object driving apparatus.

10. The device according to claim 9, wherein the handle is detachably attachable to the object.

11. The device according to claim 10, wherein:
the at least one sensor comprises at least one sensor selected from the group consisting of capacitive, magnetic, piezoelectric and strain-gauge-based force sensors and
the at least one sensor is configured to detect an amount and direction of the force being applied to the object via the handle and to output the at least one sensor output signal as a value that is proportional to the detected amount and direction of the force.

12. The device according to claim 11, wherein the handle is configured to be activatable and deactivatable such that, in an activated state of the handle, the at least one sensor output signal is generated and, in a deactivated state of the handle, no sensor output signal is generated.

13. The device according to claim 12, further comprising at least one processing device configured to amplify the at least one sensor output signal and to transmit an amplified sensor output signal to at least one motor controller located in the motorized object driving apparatus.

14. The device according to claim 13, wherein the motorized object driving apparatus is configured to move the object at least one of linearly and rotationally by an amount that is proportional to the detected amount and direction of the force and further comprises at least one motor that is controllable by the at least one motor controller.

15. The device according to claim 14, wherein the at least one motor comprises at least one electric linear motor.

16. The device according to claim 15, wherein the handle is attachable to the object such that the handle is not movable relative to the object.

17. The device according to claim 16, wherein the motorized object driving apparatus comprises a movable piston configured to mechanically move the object.

18. The device according to claim 1, wherein the handle is attachable to the object such that the handle is not movable relative to the object.

19. A method for moving an object comprising:
applying a force to a handle attached to the object,
generating at least one sensor output signal using at least one sensor disposed in or on the handle in accordance with the force detected by the at least one sensor; and
moving the object using a motorized object driving apparatus in the direction of the detected force being applied to the handle by controlling the motorized object driving apparatus, which is in electrical communication with the sensor, based on the at least one sensor output signal.

20. The method according to claim 19, wherein the force is applied by a user's hand, the at least one sensor output signal is proportional to an amount and direction of the force detected by the at least one sensor and the object is moved proportionally to the detected amount and direction of the force.
